(19) United States
(12) Patent Application Publication
(10) Pub. No.: US 2007/0213438 A1
(43) Pub. Date: Sep. 13, 2007

(54) Oil-based dispersion and oil-based ink composition

(75) Inventors: Akira Mizutani, Matsumoto-shi (JP); Takashi Oyanagi, Shiajiri-shi (JP); Keitaro Nakano, Matsumoto-shi (JP)

Correspondence Address: LADAS & PARRY, 26 WEST 61ST STREET, NEW YORK, NY, 10023, US

(73) Assignee: SEIKO EPSON CORPORATION

(21) Appl. No.: 11/714,695

(22) Filed: Mar. 6, 2007

(30) Foreign Application Priority Data
Mar. 7, 2006 (JP) P2006-061511

(51) Int. Cl. C08C 1/14

(52) U.S. Cl. 524/160

(57) ABSTRACT

The present invention provides an oil-based dispersion containing hollow polymer fine particles, wherein the above-mentioned hollow polymer fine particles contain a plurality of fine particle subgroups, and the difference in average particle size between the respective fine particle subgroups adjacent to each other in terms of average particle size is less than 100 nm. Further, an oil-based ink composition containing the above-mentioned oil-based dispersion is also disclosed.

### FIELD OF THE INVENTION

The present invention relates to an oil-based dispersion and an oil-based ink composition. The oil-based dispersion of the invention contains hollow polymer fine particles, so that it is useful for the preparation of a white ink composition. In particular, it is prepared by combining a plurality of hollow polymer fine particle subgroups different in average particle size, so that it is useful for the preparation of a white ink composition having a high level of opacifying properties.

### BACKGROUND OF THE INVENTION

It is known to use hollow polymer fine particles as a white coloring agent in a white ink composition for ink jet recording (for example, patent document 1). The hollow polymer fine particles described in the above-mentioned patent document 1 are spherical bodies having a cavity at the center of the fine particle and having an outside diameter of 1 μm or less, and are formed of a liquid-permeable polymer film. Accordingly, when present in an aqueous ink composition, the central cavity is filled with an aqueous medium. The hollow polymer fine particles filled with the aqueous medium have a specific gravity close to that of the aqueous medium, so that the problem of precipitation which occurs at the time when an inorganic pigment is used can be significantly solved to improve storage stability, ejection stability and the like of the ink composition. Further, when the ink composition containing the hollow polymer fine particles is ejected onto a medium such as recording paper, the aqueous medium is removed from the central cavity, leaving an airspace filled with air. The size of this airspace is designed so as to effectively scatter visible light. Accordingly, a white image can be formed on the medium.

In the above-mentioned patent document 1, there is specifically described an aqueous ink composition containing commercially available hollow polymer fine particles having an outside diameter of 500 nm, and it is shown that the composition is improved in opacity compared to an aqueous ink composition containing non-hollow polymer fine particles having an outside diameter of 500 nm.

It is also known to use hollow polymer fine particle groups having plural kinds of outside diameters (patent document 2). According to the description of the above-mentioned patent document 2, the hue of a white image can be controlled by using at least two kinds of hollow polymer fine particle groups different in outside diameter by 100 nm or more. Specifically, it is described that the hue as represented by the b value in the Lab method or the contribution of blue to the white image can be changed systematically and controllably by variously changing the mixing ratio of a small-sized hollow polymer fine particle group having an outside diameter of 320 nm and a large-sized hollow polymer fine particle group having an outside diameter of 900 nm.

However, the pacifying properties according to the ink composition described in the above-mentioned patent document 1 are insufficient. Further, in the above-mentioned patent document 2, no reference is made at all to the effect to the opacifying properties by combining hollow polymer fine particle groups having plural kinds of outside diameters. Moreover, the present inventors have confirmed by experiments the ink compositions specifically disclosed in the above-mentioned patent document 2. As a result, the opacifying properties were insufficient.

Concerning the above-mentioned problems, the present inventors have made studies for improving opacifying properties in an aqueous ink composition using hollow polymer fine particles as a white coloring agent prior to the invention. As the results of the studies, it has been found that opacifying properties can be improved by using a plurality of hollow polymer fine particle groups (fine particle subgroups) different in outside diameter by rather 100 nm or less, contrary to the combination described in the above-mentioned patent document 2.

Based on the above-mentioned finding, the present inventors have proposed an “aqueous dispersion containing hollow polymer fine particles, wherein the fine follow polymer particles comprise a plurality of fine particle subgroups, and the difference in average particle size between the respective fine particle subgroups adjacent to each other in terms of average particle size is less than 100 nm”, and an “aqueous ink composition containing the aqueous dispersion” (patent document 3).

Patent Document 1; U.S. Pat. No. 4,880,465

Patent Document 2: JP-A-2003-313481

Patent Document 3: U.S. application Ser. No. 11/600,336

### SUMMARY OF THE INVENTION

However, printed images using an aqueous ink are generally inferior in water resistance, and printing on a recording medium having a water-resistant surface is difficult. On the contrary, an oil-based ink has advantages that it can provide printed images excellent in water resistance, and that printing on the recording medium having the water-resistant surface also becomes easy.

Based on the above-mentioned viewpoint, the present inventors have completed the invention, giving attention particularly to “an oil-based dispersion and an oil-based ink composition”, not to “the aqueous dispersion and the aqueous ink composition” which have already been proposed as described above, and problems that the invention is to solve are to provide an oil-based dispersion useful for preparing a white ink composition having a high level of opacifying properties, and an oil-based ink composition obtained from the oil-based dispersion.

Other objects and effects of the invention will become apparent from the following description.

As a means for solving the above-mentioned problems, the oil-based dispersion according to the invention is an oil-based dispersion containing hollow polymer fine particles, wherein the above-mentioned hollow polymer fine particles comprise a plurality of fine particle subgroups, and the difference in average particle size between the respective fine particle subgroups adjacent to each other in terms of average particle size is less than 100 nm.

Further, the oil-based ink composition according to the invention relates to an oil-based ink composition which is particularly an ink for ink jet recording and contains the above-mentioned oil-based dispersion.

The oil-based dispersion of the invention comprises hollow polymer fine particle subgroups having a plurality of average particle sizes, and the ink composition prepared from this oil-based dispersion comprises hollow polymer fine particle subgroups having a plurality of average particle sizes. Accordingly, it can show a high level of opacifying properties.

### DETAILED DESCRIPTION OF THE INVENTION

The oil-based dispersion according to the invention contains hollow polymer fine particles, the hollow polymer fine particles comprise a plurality of fine particle subgroups, and the difference in average particle size between the respective fine particle subgroups adjacent to each other in terms of average particle size is less than 100 nm.

Here, “the difference in average particle size between the respective fine particle subgroups adjacent to each other in terms of average particle size is less than 100 nm” means that when the above-mentioned respective fine particle subgroups are put in order of average particle size, the difference in average particle size between the respective fine particle subgroups adjacent to each other is less than 100 nm.

In this specification, the particle size or average particle size means the particle size or average particle size measured with a particle size distribution measuring device the measuring principle of which is based on the laser diffraction scattering method. As a typical laser diffraction type particle size distribution measuring device, there can be used, for example, a particle size analyzer (for example, “Microtruck UPA” manufactured by Nikkiso Co., Ltd.) the measuring principle of which is based on the dynamic light scattering method (FFT power spectrum method).

The particle size of the hollow polymer fine particles which can be used in the oil-based dispersion of the invention is preferably from 200 nm to 1,200 nm, and more preferably from 280 nm to 1,120 nm. The difference in average particle size between the respective fine particle subgroups adjacent to each other in terms of average particle size is preferably from 30 nm to 90 nm, and more preferably from 60 nm to 80 μm. The oil-based dispersion according to the invention can be prepared by combining two or more kinds (for example, two, three, four or five kinds) of hollow polymer fine particle subgroups having different average particle sizes satisfying the above-mentioned conditions.

A preparation method of the hollow polymer fine particles used in the invention is not particularly limited, and various known methods can be used. For example, they are described in the above-mentioned patent document 1 or 2, and further, in each specification of U.S. Pat. Nos. 5,229,209, 4,594,363, 4,427,836 or 4,089,800. Further, various hollow polymer fine particles are commercially available. Furthermore, the preparation method of the above-mentioned hollow polymer fine particles and a designing method of the cavity size or the outside diameter are also known, and described, for example, in the above-mentioned respective documents. The above-mentioned hollow polymer fine particles are typically prepared according to an ordinary emulsion polymerization technique. In addition, the individual hollow polymer fine particles are dispersed in an organic liquid medium (see later description), thereby being able to prepare as a stable dispersion system. Good dispersibility is imparted to the dispersion thus obtained without necessitating a pulverization operation or a grinding operation which is necessary in preparing an ordinary pigment ink composition, and the dispersion can be utilized, for example, in the preparation of an ink composition for ink jet recording.

Vinyl monomers which can be used in the preparation of the above-mentioned hollow polymer fine particles include, for example, nonionic monoethylene unsaturated monomers, and the nonionic monoethylene unsaturated monomers include, for example, styrene, vinyltoluene, ethylene, vinyl acetate, vinyl chloride, vinylidene chloride, acrylonitrile, (meth)acrylamide, and various esters of (meth)acrylic acid such as methyl acrylate (MA), methyl methacrylate (MMA), ethyl acrylate (EA) or butyl acrylate (BA), for example, (C1-C20) alkyl or (C3-C20) alkenyl esters. Further, as the (meth)acrylic ester, there can also be used, for example, methyl methacrylate (MMA), methyl acrylate (MA), ethyl(meth) acrylate (EMA), butyl(meth)acrylate (BMA), 2-hydroxyethyl methacrylate (HEMA), 2-ethylhexyl(meth)acrylate (EHMA), benzyl (meth)acrylate, lauryl(meth)acrylate, oleyl (meth)acrylate, palmityl(meth)acrylate or stearyl (meth)acrylate.

It is also possible to form an outer shell (polymer film) by copolymerizing a bifunctional vinyl monomer, for example, divinylbenzene, allyl methacrylate, ethylene glycol dimethacrylate, 1,3-butanediol dimethacrylate, diethylene glycol dimethacrylate or trimethylolpropane trimethacrylate, to perform crosslinking.

The oil-based dispersion according to the invention can be prepared as a dispersion system in which the above-mentioned fine follow polymer particles are dispersed in the organic liquid medium. As the organic liquid media, there can be preferably used polar organic solvents, for example, alcohols (methyl alcohol, ethyl alcohol, propyl alcohol, butyl alcohol, isopropyl alcohol, a fluorinated alcohol and the like), ketones (acetone, methyl ethyl ketone, cyclohexanone and the like), carbonic acid esters (methyl acetate, ethyl acetate, propyl acetate, butyl acetate, methyl propionate, ethyl propionate and the like) and ethers (diethyl ether, dipropyl ether, tetrahydrofuran, dioxane and the like).

In addition, preferred examples of the organic liquid media include a mixture of a diethylene glycol compound which is liquid under ordinary temperature and pressure and a dipropylene glycol compound which is also liquid under ordinary temperature and pressure as described in PCT International Publication Pamphlet 2002/055619, and the like. Specifically, diethylene glycol diethyl ether and dipropylene glycol monoethyl ether can be used together, and further, triethylene glycol monomethyl ether, triethylene glycol monobutyl ether and the like can be used.

In the oil-based dispersion according to the invention, a silicone-based surfactant or a polyoxyethylene derivative as a nonionic surfactant is preferably contained in addition.

As the silicone-based surfactant, it is preferred to use a polyester-modified silicone or a polyether-modified silicone. Specific examples thereof include BYK-347, BYK-348, BYK-UV3500, 3510, 3530 and 3570 (all are manufactured by BYK Chemie Japan). Further, as the polyoxyethylene derivative, there can be used an acetylene glycol-based surfactant. Specific examples thereof include Surfynol 104, 82, 465, 485 and TG (all are trade names of Air Products and Chemicals, Inc.), and Olfine STG and Olfine E1010 (both are trade names of Nisshin Chemical Industry Co., Ltd.). Other commercial products include Nissan Nonion A-10R and A-13R (manufactured by NOF Corporation), Flowlen TG-740W and D-90 (Kyoeisha Chemical Co., Ltd.) and Noigen CX-100 (Dai-Ichi Kogyo Seiyaku Co., Ltd.).

In the oil-based dispersion according to the invention, the content (solid content) of the hollow polymer fine particles is not particularly limited. For example, however, it is preferably form 10 to 90% by weight, and more preferably from 20 to 80% by weight, based on the total weight of the above-mentioned oil-based dispersion. Further, the mixing ratio of the individual hollow polymer fine particle subgroups contained in the oil-based dispersion of the invention is also not particularly limited as long as the opacifying properties of an ink composition prepared from this oil-based dispersion can be well expressed. When two or more kinds of hollow polymer fine particle subgroups are mixed to use, the solid contents of the respective fine particle subgroups may be at least 5% by weight or more based on the total solid content of the mixed hollow polymer fine particles.

The ink composition according to the invention can be prepared from the above-mentioned oil-based dispersion by a known method. The oil-based ink composition of the invention may contain various known additives, in addition to the above-mentioned hollow polymer fine particle-containing oil-based dispersion medium. As the additives, there can be used ordinary additives contained in an ordinary ink composition. In particular, when an ink composition for ink jet recording is prepared, additives ordinarily used in the preparation of an ink composition for ink jet recording can be used.

In the oil-based ink composition of the invention, the content of the above-mentioned hollow polymer fine particles is not particularly limited, as long as the opacifying properties can be well expressed. For example, however, it is preferably form 5 to 90% by weight, and more preferably from 10 to 80% by weight, based on the total weight of the above-mentioned ink composition. In addition, the mixing ratio of the individual hollow polymer fine particle subgroups contained in the ink composition of the invention is the same as the mixing ratio in the above-mentioned oil-based dispersion.

The oil-based ink composition of the invention can be imparted as a white ink to any recording medium. As for the recording medium, the ink composition can be imparted, for example, to a medium such as paper, cardboard, a textile product (for example, a woven fabric), a natural or synthetic sheet or film, plastic, glass or ceramic. Further, the ink composition of the invention can be applied to any printing system, and can be utilized, for example, by various printers of a thermal ink jet, a piezoelectric ink jet, a continuous ink jet, roller application, spray application and the like.

### EXAMPLES

The present invention will be illustrated in grater detail with reference to the following Examples and Comparative Examples, but the invention should not be construed as being limited to the Examples.

The parts described in the following <production methods of hollow polymer fine particle emulsions> are given by weight.

<Production Methods of Hollow Polymer Fine Particle Emulsions>

(1) Polymer Particles 1

In a 2-liter reaction vessel were placed 80 parts of styrene, 5 parts of methacrylic acid, 15 parts of methyl methacrylate, 1 part of an α-methylstyrene dimer, 14 parts of t-dodecylmercaptan, 0.8 part of sodium dodecylbenzene-sulfonate, 1.0 part of potassium persulfate and 200 parts of water, followed by stirring in a nitrogen gas. The resulting mixture was heated to 80° C., and emulsion polymerization was conducted for 6 hours. Polymer particles 1 obtained thereby had an average particle size of 150 nm (0.15 μm).

(2) Hollow Polymer Fine Particle Emulsion 1

Together with 10 parts (in terms of solid content) of polymer particles 1 obtained in the above section (1), 0.3 part of sodium laurylsulfate, 0.5 part of potassium persulfate and 400 parts of water were placed in a reaction vessel, and a crosslinking polymerizable monomer composition comprising a mixture of 11.6 parts (purity: 55% by weight, remainder: a monofunctional vinyl monomer) of divinylbenzene, 8.4 parts of ethylvinylbenzene, 5 parts of acrylic acid and 75 parts of methyl methacrylate was added thereto, followed by stirring at 30° C. for 1 hour. Then, emulsion polymerization treatment was conducted with further stirring at 70° C. for 5 hours to obtain an aqueous dispersion. The resulting one was measured with a particle size analyzer (Microtruck UPA: Nikkiso Co., Ltd.). As a result, the particle size of the dispersed fine particles was 320 nm. Separately, the particles were observed under a transmission electron microscope. As a result, they were hollow polymer fine particles. The emulsion thus obtained is taken as hollow polymer fine particle emulsion 1.

(3) Hollow Polymer Fine Particle Emulsions 2 to 5 and 7

Hollow polymer fine particle emulsions 2 to 5 and 7 were obtained in the same manner as in the above section (2) “Hollow polymer fine particle Emulsion 1” with the exception that polymer particles 1 to 5 obtained by compositions shown in Table 1 and compositions shown in Table 2 were used.

(4) Hollow Polymer Fine Particle Emulsion 6

A reaction vessel was charged with 2 parts of polymer particles 1 obtained in the above section (1), 20 parts of polyvinyl alcohol, 2 parts of a polymerization initiator, 3,5,5-trimethylhexanoyl peroxide, and 500 parts of water, and a mixture of a crosslinking polymerizable monomer composition comprising a mixture of 25 parts of ethylene glycol dimethacrylate, 5 parts of methacrylic acid and 70 parts of methyl methacrylate and 400 parts of toluene was added thereto, followed by stirring at 40° C. for 2 hours. Then, emulsion polymerization treatment was conducted with further stirring at 70° C. for 15 hours to obtain an aqueous dispersion. The emulsion thus obtained is taken as hollow polymer fine particle emulsion 6.

TABLE 1

| | Polymer Particles | | | | |
|---|---|---|---|---|---|
| Composition (parts) | 1 | 2 | 3 | 4 | 5 |
| Styrene | 80 | 80 | 80 | 100 | 80 |
| Methyl Methacrylate | 15 | 15 | 7 | | 15 |
| Methacrylic Acid | 5 | 5 | | | |
| Acrylonitrile | | | 8 | | |
| Acrylic Acid | | | 5 | | 5 |
| α-Methylstyrene Dimer | 1 | 2 | 1 | 1 | |
| Average Particle Size (nm) | 150 | 200 | 550 | 250 | 300 |

TABLE 2

| | | Hollow Polymer Fine Particle Emulsion | | | | | | |
|---|---|---|---|---|---|---|---|---|
| | | 1 | 2 | 3 | 4 | 5 | 6 | 7 |
| Polymer | Kind | 1 | 2 | 1 | 4 | 5 | 1 | 3 |
| Particles | Amount Used (parts) | 10 | 10 | 5 | 10 | 10 | 2 | 10 |
| Monomers | Divinylbenzene | 11.6 | 11.6 | 11.6 | 11.6 | 11.6 | | 11.6 |
| (parts) | Ethylene Glycol Dimethacrylate | | | | | | 25 | |
| | Styrene | | 5 | 5 | | | | 5 |
| | Ethylvinylbenzene | 8.4 | 8.4 | 8.4 | 8.4 | 8.4 | | 8.4 |
| | Acrylic Acid | 5 | | 5 | | 5 | | |
| | Methacrylic Acid | | 5 | | 5 | | 5 | 5 |
| | Methyl Methacrylate | 75 | 75 | 75 | 75 | 75 | 70 | 75 |

| | | | | | | | |
|---|---|---|---|---|---|---|---|
| Particle Size (nm) | 320 | 400 | 460 | 520 | 840 | 920 | 1000 |

The above-mentioned aqueous dispersions were each dried and solidified, and then, the resulting hollow polymer fine particle emulsions were used in various combinations to prepare ink compositions 1 to 10 according to the invention (Examples 1 to 10) and ink compositions 1 and 2 for comparison (Comparative Examples 1 and 2) as shown below.

### Example 1

| | | |
|---|---|---|
| Hollow polymer fine particle emulsion 1 | 5% | by weight |
| (particle size: 320 nm) | | |
| Hollow polymer fine particle emulsion 2 | 5% | by weight |
| (particle size: 400 nm) | | |
| Hollow polymer fine particle emulsion 3 | 5% | by weight |
| (particle size: 460 nm) | | |
| Glycerol | 20% | by weight |
| Triethylene glycol monobutyl ether | 40% | by weight |
| BYK 348 (silicone-based surfactant manufactured | 0.3% | by weight |
| by BYK Chemie Japan) | | |

| | |
|---|---|
| IPA (isopropyl alcohol) | balance |

### Example 2

| | | |
|---|---|---|
| Hollow polymer fine particle emulsion 2 | 5% | by weight |
| (particle size: 400 nm) | | |
| Hollow polymer fine particle emulsion 3 | 5% | by weight |
| (particle size: 460 nm) | | |
| Hollow polymer fine particle emulsion 4 | 5% | by weight |
| (particle size: 520 nm) | | |
| Glycerol | 20% | by weight |
| Triethylene glycol monobutyl ether | 40% | by weight |
| BYK 348 (silicone-based surfactant manufactured | 0.3% | by weight |
| by BYK Chemie Japan) | | |

| | |
|---|---|
| IPA (isopropyl alcohol) | balance |

### Example 3

| | | |
|---|---|---|
| Hollow polymer fine particle emulsion 1 | 3% | by weight |
| (particle size: 320 nm) | | |
| Hollow polymer fine particle emulsion 2 | 4% | by weight |
| (particle size: 400 nm) | | |
| Hollow polymer fine particle emulsion 3 | 4% | by weight |
| (particle size: 460 nm) | | |
| Hollow polymer fine particle emulsion 4 | 4% | by weight |
| (particle size: 520 nm) | | |
| Glycerol | 20% | by weight |
| Triethylene glycol monobutyl ether | 40% | by weight |
| BYK 348 (silicone-based surfactant manufactured | 0.3% | by weight |
| by BYK Chemie Japan) | | |

| | |
|---|---|
| IPA (isopropyl alcohol) | balance |

### Example 4

| | | |
|---|---|---|
| Hollow polymer fine particle emulsion 6 | 7% | by weight |
| (particle size: 920 nm) | | |
| Hollow polymer fine particle emulsion 7 | 8% | by weight |
| (particle size: 1000 nm) | | |
| Glycerol | 20% | by weight |
| Triethylene glycol monobutyl ether | 40% | by weight |
| BYK 348 (silicone-based surfactant manufactured | 0.3% | by weight |
| by BYK Chemie Japan) | | |

| | |
|---|---|
| IPA (isopropyl alcohol) | balance |

### Example 5

| | | |
|---|---|---|
| Hollow polymer fine particle emulsion 5 | 5% | by weight |
| (particle size: 840 nm) | | |
| Hollow polymer fine particle emulsion 6 | 5% | by weight |
| (particle size: 920 nm) | | |
| Hollow polymer fine particle emulsion 7 | 5% | by weight |
| (particle size: 1000 nm) | | |
| Glycerol | 20% | by weight |
| Triethylene glycol monobutyl ether | 40% | by weight |
| BYK 348 (silicone-based surfactant manufactured | 0.3% | by weight |
| by BYK Chemie Japan) | | |

| | |
|---|---|
| IPA (isopropyl alcohol) | balance |

### Example 6

| | | |
|---|---|---|
| Hollow polymer fine particle emulsion 1 | 5% | by weight |
| (particle size: 320 nm) | | |
| Hollow polymer fine particle emulsion 2 | 5% | by weight |
| (particle size: 400 nm) | | |
| Hollow polymer fine particle emulsion 3 | 5% | by weight |
| (particle size: 460 nm) | | |
| BYK 348 (silicone-based surfactant manufactured | 0.5% | by weight |
| by BYK Chemie Japan) | | |
| Diethylene glycol diethyl ether | 22% | by weight |
| Triethylene glycol monomethyl ether | 27% | by weight |
| Dipropylene glycol monomethyl ether | 27% | by weight |
| γ-Butyrolactone | 8.5% | by weight |

### Example 7

| | | |
|---|---|---|
| Hollow polymer fine particle emulsion 2 | 5% | by weight |
| (particle size: 400 nm) | | |
| Hollow polymer fine particle emulsion 3 | 5% | by weight |
| (particle size: 460 nm) | | |
| Hollow polymer fine particle emulsion 4 | 5% | by weight |
| (particle size: 520 nm) | | |
| BYK 348 (silicone-based surfactant manufactured | 0.5% | by weight |
| by BYK Chemie Japan) | | |
| Diethylene glycol diethyl ether | 22% | by weight |
| Triethylene glycol monomethyl ether | 27% | by weight |
| Dipropylene glycol monomethyl ether | 27% | by weight |
| γ-Butyrolactone | 8.5% | by weight |

### Example 8

| | | |
|---|---|---|
| Hollow polymer fine particle emulsion 1 | 3% | by weight |
| (particle size: 320 nm) | | |
| Hollow polymer fine particle emulsion 2 | 4% | by weight |
| (particle size: 400 nm) | | |
| Hollow polymer fine particle emulsion 3 | 4% | by weight |
| (particle size: 460 nm) | | |
| Hollow polymer fine particle emulsion 4 | 4% | by weight |
| (particle size: 520 nm) | | |
| BYK 348 (silicone-based surfactant manufactured | 0.5% | by weight |
| by BYK Chemie Japan) | | |
| Diethylene glycol diethyl ether | 22% | by weight |
| Triethylene glycol monomethyl ether | 27% | by weight |
| Dipropylene glycol monomethyl ether | 27% | by weight |
| γ-Butyrolactone | 8.5% | by weight |

### Example 9

| | | |
|---|---|---|
| Hollow polymer fine particle emulsion 6 | 7% | by weight |
| (particle size: 920 nm) | | |
| Hollow polymer fine particle emulsion 7 | 8% | by weight |
| (particle size: 1000 nm) | | |
| BYK 348 (silicone-based surfactant manufactured | 0.5% | by weight |
| by BYK Chemie Japan) | | |
| Diethylene glycol diethyl ether | 22% | by weight |
| Triethylene glycol monomethyl ether | 27% | by weight |
| Dipropylene glycol monomethyl ether | 27% | by weight |
| γ-Butyrolactone | 8.5% | by weight |

### Example 10

| | | |
|---|---|---|
| Hollow polymer fine particle emulsion 5 | 5% | by weight |
| (particle size: 840 nm) | | |
| Hollow polymer fine particle emulsion 6 | 5% | by weight |
| (particle size: 920 nm) | | |
| Hollow polymer fine particle emulsion 7 | 5% | by weight |
| (particle size: 1000 nm) | | |
| BYK 348 (silicone-based surfactant manufactured | 0.5% | by weight |
| by BYK Chemie Japan) | | |
| Diethylene glycol diethyl ether | 22% | by weight |
| Triethylene glycol monomethyl ether | 27% | by weight |
| Dipropylene glycol monomethyl ether | 27% | by weight |
| γ-Butyrolactone | 8.5% | by weight |

### Comparative Example 1

| | |
|---|---|
| Titanium oxide | 15% by weight |
| Glycerol | 20% by weight |
| Triethylene glycol monobutyl ether | 40% by weight |
| BYK 348 (silicone-based surfactant manufactured | 0.3% by weight |
| by BYK Chemie Japan) | |
| IPA (isopropyl alcohol) | balance |

### Comparative Example 2

| | |
|---|---|
| Titanium oxide | 15% by weight |
| BYK 348 (silicone-based surfactant manufactured | 0.3% by weight |
| by BYK Chemie Japan) | |
| Diethylene glycol diethyl ether | 22% by weight |
| Triethylene glycol monomethyl ether | 27% by weight |
| Dipropylene glycol monomethyl ether | 27% by weight |
| γ-Butyrolactone | 8.5% by weight |

(Evaluation of Storage Stability)

The above-mentioned ink compositions of Examples 1 to 10 and Comparative Examples 1 and 2 were each placed in a sample bottle, and allowed to stand at normal temperature for 2 weeks, followed by visual observation. The evaluation criteria were as follows:

A: No precipitation of a color material is observed.

B: A color material is slightly precipitated.

C: A color material is almost precipitated.

(Evaluation of Opacifying Properties)

Black monochromatic characters were printed on photo mat paper/used exclusively for pigments (manufactured by Seiko Epson Corporation) with a PX-A550 printer (manufactured by Seiko Epson Corporation), and an Epson exclusive OHP sheet (manufactured by Seiko Epson Corporation) on which the above-mentioned ink compositions of Examples 1 to 10 and Comparative Examples 1 and 2 had each been printed with the PX-A550 printer was superposed thereon. Then, the visibility of the characters was visually evaluated. The evaluation criteria were as follows:

A: The characters of the printed matter on which the OHP sheet has been superposed can be slightly read.

B: The characters of the printed matter on which the OHP sheet has been superposed can be almost read.

C: The characters of the printed matter on which the OHP sheet has been superposed can be clearly read.

The above-mentioned evaluation of storage stability and evaluation of opacifying properties are shown in Table 3. In addition, the above-mentioned oil-based ink compositions of Examples 1 to 10 and Comparative Examples 1 and 2 are summarized in Table 3.

TABLE 3

| | | | | | | | | | | | Comparative | |
|---|---|---|---|---|---|---|---|---|---|---|---|---|
| | Example | | | | | | | | | | Example | |
| | 1 | 2 | 3 | 4 | 5 | 6 | 7 | 8 | 9 | 10 | 1 | 2 |
| Hollow polymer fine particles 1 (320 nm) | 5 | — | 3 | — | — | 5 | — | 3 | — | — | — | — |
| Hollow polymer fine particles 2 (400 nm) | 5 | 5 | 4 | — | — | 5 | 5 | 4 | — | — | — | — |
| Hollow polymer fine particles 3 (460 nm) | 5 | 5 | 4 | — | — | 5 | 5 | 4 | — | — | — | — |
| Hollow polymer fine particles 4 (520 nm) | — | 5 | 4 | — | — | — | 5 | 4 | — | — | — | — |
| Hollow polymer fine particles 5 (840 nm) | — | — | — | — | 5 | — | — | — | — | 5 | — | — |
| Hollow polymer fine particles 1 (920 nm) | — | — | — | 7 | 5 | — | — | — | 7 | 5 | — | — |
| Hollow polymer fine particles 1 (1000 nm) | — | — | — | 8 | 5 | — | — | — | 8 | 5 | — | — |
| Titanium Oxide | — | — | — | — | — | — | — | — | — | — | 15 | 15 |
| Glycerol | 20 | 20 | 20 | 20 | 20 | — | — | — | — | — | 20 | — |
| Triethylene Glycol Monobutyl Ether | 40 | 40 | 40 | 40 | 40 | — | — | — | — | — | 40 | — |
| BYK 348 | 0.3 | 0.3 | 0.3 | 0.3 | 0.3 | 0.5 | 0.5 | 0.5 | 0.5 | 0.5 | 0.3 | 0.5 |
| IPA (Isopropyl Alcohol) | Bal. | Bal. | Bal. | Bal. | Bal. | — | — | — | — | — | Bal. | — |
| Diethylene Glycol Diethyl Ether | — | — | — | — | — | 22 | 22 | 22 | 22 | 22 | — | 22 |
| Triethylene Glycol Monomethyl Ether | — | — | — | — | — | 27 | 27 | 27 | 27 | 27 | — | 27 |
| Dipropylene Glycol Monomethyl Ether | — | — | — | — | — | 27 | 27 | 27 | 27 | 27 | — | 27 |
| γ-Butyrolactone | — | — | — | — | — | 8.5 | 8.5 | 8.5 | 8.5 | 8.5 | — | 8.5 |
| Evaluation of Storage Stability | A | A | A | A | A | A | A | A | A | A | C | C |
| Evaluation of Opacifying Properties | A | A | A | A | A | A | A | A | A | A | B | B |

(Note:
Numerical value unit in Examples and Comparative Examples = % by weight)

As apparent from Table 3, both the storage stability and the opacifying properties were evaluated as “A” in Examples 1 to 10, whereas the storage stability was evaluated as “C” and the opacifying properties as “B” in Comparative Examples 1 and 2.

As described in detail above, according to the invention, there can be provided the oil-based dispersion useful for the preparation of the white ink composition having a high level of opacifying properties, and the oil-based ink composition obtained from that oil-based dispersion. Accordingly, the availability thereof is extremely significant.

While the present invention has been described in detail and with respect to specific embodiments thereof, it will be apparent to one skilled in the art that various changes and modifications can be made therein without departing from the spirit and scope thereof.

This application is based on Japanese Patent Application No. 2006-061511 filed Mar. 7, 2006, and the contents thereof are herein incorporated by reference.

What is claimed is:

1. An oil-based dispersion containing hollow polymer fine particles, wherein the hollow polymer fine particles comprise a plurality of fine particle subgroups, and the difference in average particle size between the respective fine particle subgroups adjacent to each other in terms of average particle size is less than 100 nm.

2. An oil-based ink composition comprising the oil-based dispersion according to claim 1.
